(19) United States
(12) Patent Application Publication
(10) Pub. No.: US 2016/0119767 A1
(43) Pub. Date: Apr. 28, 2016

(54) System for Providing Centralized Connected Vehicle Services

(71) Applicant: Sirius XM Connected Vehicle Services Inc., Irving, TX (US)

(72) Inventors: Peter Paul Polit, Indianapolis, IN (US); Tod Farrell, Coppell, TX (US); Blake Alan Bowen, Carrollton, TX (US); Dennie Bengt-Ake Danielsson, Colleyville, TX (US); James A. Cady, Beaverton, OR (US)

(21) Appl. No.: 14/919,895

(22) Filed: Oct. 22, 2015

Related U.S. Application Data
(60) Provisional application No. 62/069,134, filed on Oct. 27, 2014.

(51) Int. Cl. H04W 4/22; H04L 29/08; H04W 4/02; H04W 76/00

(52) U.S. Cl. CPC H04W 4/22; H04W 76/007; H04L 67/12; H04W 4/02

(57) ABSTRACT

A system for providing centralized connected vehicle services includes a vehicle communicating through a communications device that is a wireless access device embedded within the vehicle and/or a mobile wireless access device, the communications device transmitting at least one of language data from the vehicle indicating a language spoken by a customer within the vehicle and a voice call from the wireless access device. A central call center is communicatively connected to at least one of the vehicle and the wireless access device. A central computer server is co-located with the central call center, communicatively connected to the central call center, facilitates the voice call with the wireless access device, and automatically routes the voice call to the central call center. The central call center automatically plays a recorded message through the central computer server to the wireless access device in the language of the customer.

### CROSS-REFERENCE TO RELATED APPLICATIONS

This application claims the priority, under 35 U.S.C. §119, of copending U.S. Provisional Patent Application No. 62/069,134, filed Oct. 27, 2014; the prior application is herewith incorporated by reference herein in its entirety.

### STATEMENT REGARDING FEDERALLY SPONSORED RESEARCH OR DEVELOPMENT

Not Applicable

### FIELD OF THE INVENTION

The present invention lies in the field of connected vehicle services. The present disclosure relates to a centralized connected vehicle services system that supports complex platforms and a diverse set of languages.

### BACKGROUND OF THE INVENTION

Connected Vehicle services allow online services to vehicle owners and drivers using an embedded wireless access device. Services may include agent-delivered services (e.g., automatic crash notification (ACN), emergency and/or distress communications (SOS), points of interest (POI) download, etc.) and remote services (e.g., remote door control, remote start, vehicle locator), and/or data services (e.g., remote diagnostics, virtual dashboard).

While international Connected Vehicle solutions are still in the infancy stage, those that do exist require dedicated service sites, call centers, and wireless access to manage each individual region. To explain the current state of vehicle service provider systems, reference is made to FIG. 1. Each geographical region 10 requires four components for successful communication: a call center 12, a service back end 14, a wireless carrier 16, and a vehicle 18 that is located within the geographical region 10. If a service call in one originating region 10 requires assistance from or communication to another receiving region 10, then service is provided in a fragmented fashion because each region requires its own call center 12 to use its own service back end 14 and to communicate to the originating call center 12 through a wireless carrier 16 that is present in that receiving region 10. To go through a typical communications scenario, an example of a vehicle 18 located within South America having a U.S.-based user is examined. That user needs to obtain service from its home provider in the U.S. The vehicle 18 communicates through a local South America wireless carrier 16 to the South America service back end 14. The South America service back end 14 is monitored by a South America call center 12 who initiates a call to the call center 12 in the U.S. Then, the U.S. call center 12 processes and assists with the service and utilizes the U.S. service back end 14 when needed. There is significant duplication of effort in such a scenario. A truly international rollout with the inclusion of so many communication providers costs too much money due to the multi-site call center infrastructure with many different requirements for language handling and with too many direct phone numbers around the world.

This leads to significant cost and complexity issues that have limited the expansion of services on a truly global basis. More particularly, with geographically diverse platforms 14 and call centers 12, each geographic location 10 needs to perform its own set of tests and provide individual support, which is multiplied for each geographic location 10 that addresses one service instance. Supporting a diverse set of languages presents a further challenge to efficiently support all customers in a given region 10, even when those regions 10 support a limited population of users. 18

Thus, a need exists to overcome the problems with the prior art systems, designs, and processes as discussed above and to minimize the amount of repeated tests and/or support.

### SUMMARY OF THE INVENTION

The invention provides a centralized connected vehicle services system that overcomes the hereinafore-mentioned disadvantages of the heretofore-known devices and methods of this general type and that provide such features with a complex multi-lingual platform.

The multi-lingual platform provides a single server system and back end and leverages that technology by extending it to all other geographical locations through existing wireless carriers. As used herein, a “single server” means single logical server that, for robustness, can be a geographically diverse redundant set of computers that perform a service with the end client device. The platform takes the previously fragmented architecture and moves it to a centralized location but still allows services to be provided across the globe. The platform performs this by leveraging the global cellular roaming network to rely on the carriers' intercellular agreements to bring the data back to the central location. The platform provides a highly skilled, task trained agent capable of speaking to the vehicle requesting service (customer) and, when translation services are needed, an agent skilled in the needed language is allocated to the call to dialog with the customer and emergency dispatch personnel (PSAP).

With the foregoing and other objects in view, there is provided, in accordance with one embodiment, a system for providing centralized connected vehicle services. The system includes a vehicle, a central server, and a central call center. The vehicle has an embedded or brought in wireless access device. The central server receives language data from the vehicle. The language data indicates a language spoken by a customer in the vehicle. The central server facilitates a voice call with the embedded wireless access device of the vehicle. The central server can automatically route the voice call to a central call center. The central call center is co-located with the central server. The central call center can automatically play a recorded message through the central server to the embedded wireless access device of the vehicle in the language of the customer.

Although the invention is illustrated and described herein as embodied in a centralized connected vehicle services system, it is, nevertheless, not intended to be limited to the details shown because various modifications and structural changes may be made therein without departing from the spirit of the invention and within the scope and range of equivalents of the claims. Additionally, well-known elements of exemplary embodiments of the invention will not be described in detail or will be omitted so as not to obscure the relevant details of the invention.

Additional advantages and other features characteristic of the present invention will be set forth in the detailed description that follows and may be apparent from the detailed description or may be learned by practice of exemplary embodiments of the invention. Still other advantages of the invention may be realized by any of the instrumentalities, methods, or combinations particularly pointed out in the claims.

Other features that are considered as characteristic for the invention are set forth in the appended claims. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one of ordinary skill in the art to variously employ the present invention in virtually any appropriately detailed structure. Further, the terms and phrases used herein are not intended to be limiting; but rather, to provide an understandable description of the invention. While the specification concludes with claims defining the features of the invention that are regarded as novel, it is believed that the invention will be better understood from a consideration of the following description in conjunction with the drawing figures, in which like reference numerals are carried forward.

### BRIEF DESCRIPTION OF THE DRAWINGS

The accompanying figures, where like reference numerals refer to identical or functionally similar elements throughout the separate views, which are not true to scale, and which, together with the detailed description below, are incorporated in and form part of the specification, serve to illustrate further various embodiments and to explain various principles and advantages all in accordance with the present invention. Advantages of embodiments of the present invention will be apparent from the following detailed description of the exemplary embodiments thereof, which description should be considered in conjunction with the accompanying drawings in which:

FIG. 1 is a map of the world with a diagram of prior art diverse vehicle call centers each having an individual server to service local vehicles;

FIG. 2 is a map of the world with a diagram of an exemplary embodiment of a centralized connected vehicle call center having a centralized server to service vehicles throughout the world;

FIG. 3 is an illustration of an exemplary embodiment of a centralized connected vehicle services system; and

FIG. 4 is a process flow diagram of an exemplary embodiment of a process for implementing a centralized connected vehicle services system.

### DETAILED DESCRIPTION OF THE INVENTION

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting; but rather, to provide an understandable description of the invention. While the specification concludes with claims defining the features of the invention that are regarded as novel, it is believed that the invention will be better understood from a consideration of the following description in conjunction with the drawing figures, in which like reference numerals are carried forward.

Alternate embodiments may be devised without departing from the spirit or the scope of the invention. Additionally, well-known elements of exemplary embodiments of the invention will not be described in detail or will be omitted so as not to obscure the relevant details of the invention.

Before the present invention is disclosed and described, it is to be understood that the terminology used herein is for the purpose of describing particular embodiments only and is not intended to be limiting. The terms “a” or “an”, as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically.

Relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

As used herein, the term “about” or “approximately” applies to all numeric values, whether or not explicitly indicated. These terms generally refer to a range of numbers that one of skill in the art would consider equivalent to the recited values (i.e., having the same function or result). In many instances these terms may include numbers that are rounded to the nearest significant figure.

It will be appreciated that embodiments of the invention described herein may be comprised of one or more conventional processors and unique stored program instructions that control the one or more processors to implement, in conjunction with certain non-processor circuits and other elements, some, most, or all of the functions of the powered injector devices described herein. The non-processor circuits may include, but are not limited to, signal drivers, clock circuits, power source circuits, and user input and output elements. Alternatively, some or all functions could be implemented by a state machine that has no stored program instructions, or in one or more application specific integrated circuits (ASICs) or field-programmable gate arrays (FPGA), in which each function or some combinations of certain of the functions are implemented as custom logic. Of course, a combination of these approaches could also be used. Thus, methods and means for these functions have been described herein.

The terms “program,” “software,” “software application,” and the like as used herein, are defined as a sequence of instructions designed for execution on a computer system. A “program,” “software,” “application,” “computer program,” or “software application” may include a subroutine, a function, a procedure, an object method, an object implementation, an executable application, an applet, a servlet, a source code, an object code, a shared library/dynamic load library and/or other sequence of instructions designed for execution on a computer system.

Herein various embodiments of the present invention are described. In many of the different embodiments, features are similar. Therefore, to avoid redundancy, repetitive description of these similar features may not be made in some circumstances. It shall be understood, however, that description of a first-appearing feature applies to the later described similar feature and each respective description, therefore, is to be incorporated therein without such repetition.

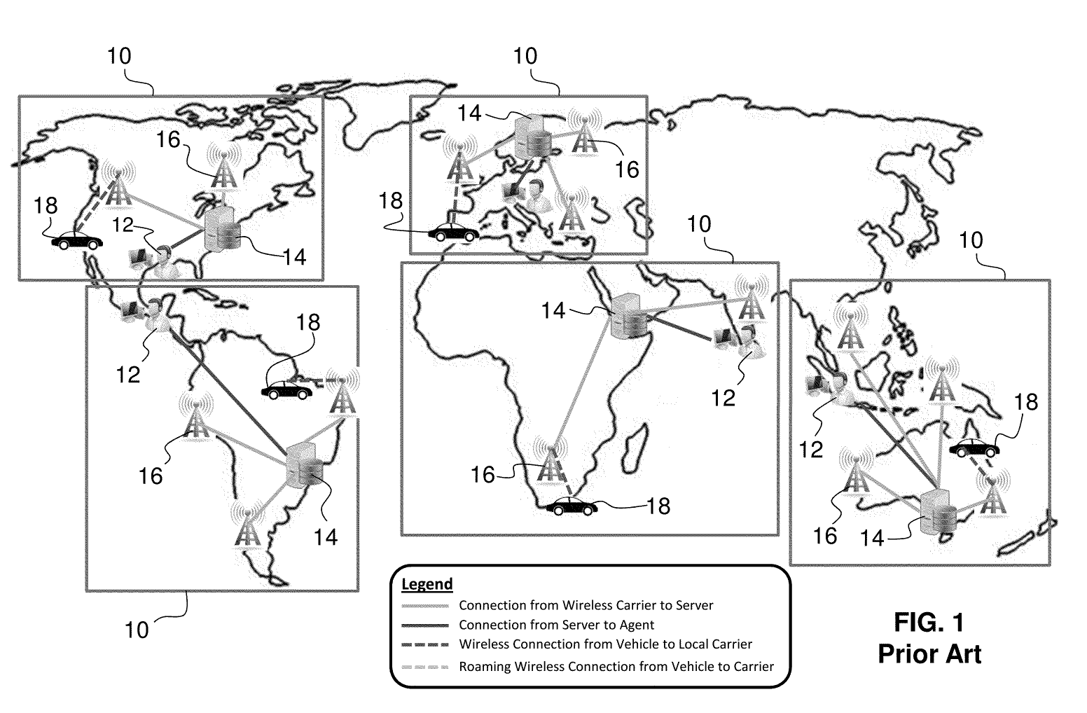

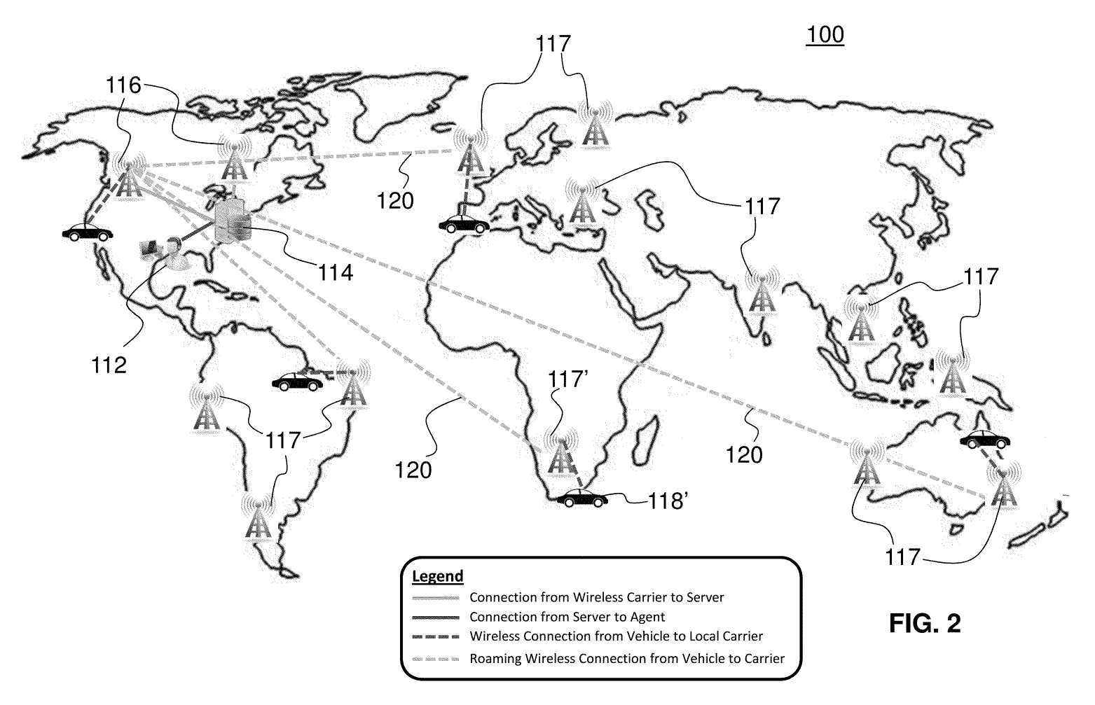

Described now are exemplary embodiments of the present invention. Referring now to the figures of the drawings in detail and first, particularly to FIG. 2, there is shown an international connected vehicle platform 100. As can be seen in comparison to the current state of the art shown in FIG. 1, international connected vehicle platform 100 eliminates all but one of the call centers 12 and all but one of the service back ends 14, leaving only a central call center 112 and one service back end 114. The international connected vehicle platform 100 includes a central telematics service provider (TSP) architecture and call center with agent-based translation to service vehicles in multiple worldwide regions. The bulk of the international connected vehicle platform 100 is centrally located in one location, which, in the example of FIG. 2, is located in the U.S. Provided in the international connected vehicle platform 100 is the central call center 112 and the central service back end 114. With the connection of the central service back end 114 to any one of a number of local wireless carriers 116, the international connected vehicle platform 100 leverages each of the agreements between those local wireless carriers 116 and wireless carriers 117 located across the globe. Thus, a vehicle 118′ in South Africa, for example, would make a service request through its local wireless carrier 117′ and, based upon the agreement between that local wireless carrier 117′ and one of the wireless carriers 116 local to the central service back end 114, a data and/or voice request will be processed directly by the central call center 112 and using the central service back end 114. This centralized location provides the advantages of better distribution of resources (both technology and agent resources) and the ability to better support complex multi-lingual platforms. If, in this example, the service request is made by an English-speaking user in South Africa, then translation services might not be an issue. However, the international connected vehicle platform 100 is able to service vehicles 118 in every country, thereby making translation services virtually mandatory.

As additional regions across the world gain access to connected vehicle services, providers must consider the challenges of supporting multiple languages, even when those languages are not widely used across the globe. The international connected vehicle platform 100 interfaces with real-time translation agents and deploys audible prompts in the customer's native language to access virtually any language and support that language with minimal effort and lower cost. A single worldwide wireless roaming solution is utilized to allow access to the wireless network in all required countries. Access to worldwide wireless roaming allows a single hardware solution to operate in any wireless network and provides a single communication path 120 from the vehicle to the international connected vehicle platform 100. These communication paths 120 leverage the global cellular roaming network and rely on carriers' intercellular agreements to bring the data back to the central location.

In particular, the single location of the central call center 112 and the central service back end 114 allows the international connected vehicle platform 100 to include a full staff of highly skilled, task-trained agents to support voice calls (ACN, SOS, etc). All vehicles 118, regardless of country of sale or current location, contact this central location 112, 114 over their local wireless network 117. When a user/customer starts a service request, an automated audio prompt is presented to the user in the language currently associated with the customer's vehicle. The call is presented at the central call center 112 to the highly skilled, task-trained agent. This live agent may speak a number of languages but may not be fluent in the language needed to address the service request of the particular user. These languages (for example, English, Spanish, French, and German) can be supported by highly skilled, task-trained, native speakers in the central call center 112. Other languages can be supported as needed through third-party translation services already under contract with and available 24/7 to the platform 100. The central call center 112, therefore, has any number of agents fluent in almost all languages and, where needed, one of these agents is automatically conferenced in from anywhere in the world to support the customer in their language of choice. In one exemplary embodiment, the customer's language preference can be stored in the vehicle and sent to the central platform along with or separate from the service request data. Additionally, or alternatively, the customer's language preference can be stored at the central platform, for example, in the central service back end 114. Where needed, customer data required to support the connected vehicle services can be hosted on cloud-based servers 114 in locations as required by local legislation. In summary, the international connected vehicle platform 100 uses a dynamically assigned translator to assist the highly skilled, task-trained agent and does so with a single centralized phone number good throughout the world and with automatic language routing.

The call center can further support emergency services dispatching when required through regional PSAP databases, which indicate the appropriate provider based on the vehicle's current location. In such a situation, the live, highly skilled, task-trained agent of the call center 112 can access a central PSAP database to assist with the service call.

Although the exemplary embodiments described herein relate primarily to connected vehicle services, the international connected vehicle platform 100 can be applied to smartphones and personal handheld devices where data or voice services are provided on an international/multi-language scale.

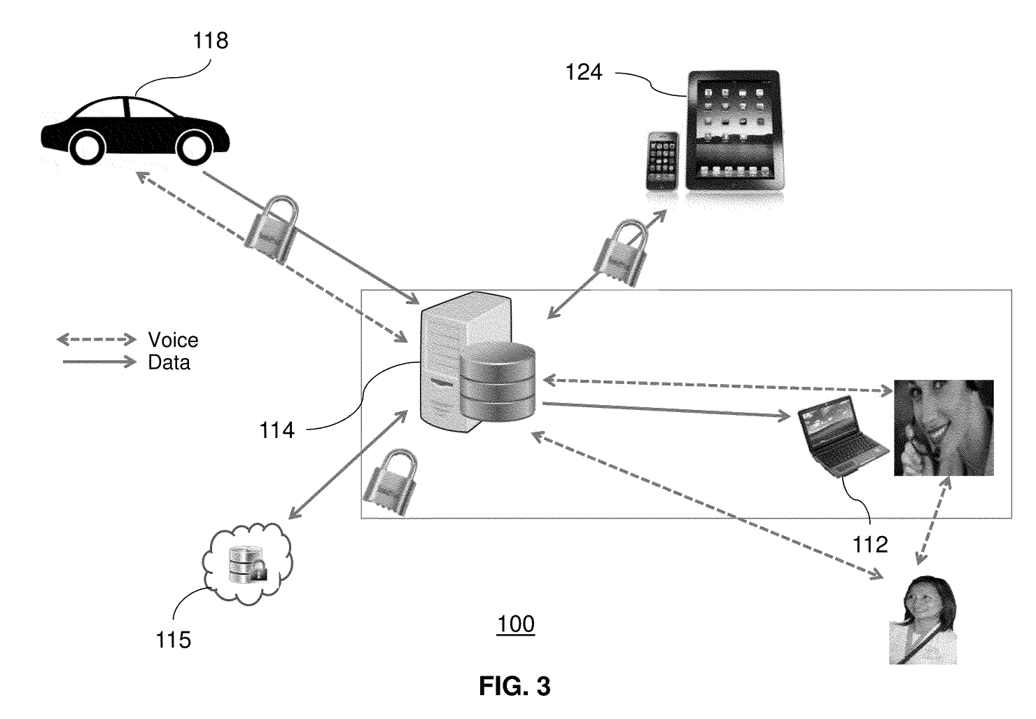

With regard to FIG. 3, there is shown an exemplary embodiment of an international connected vehicle platform 100 and methods for providing connected vehicle services from a central platform. International connected vehicle platform 100 includes a vehicle 118, which includes a wireless access device that communicates with connected vehicle platform, e.g., a central service back end 114. The wireless access device can be embedded in the vehicle 118 and/or can be a mobile wireless access device, such as a smartphone. The vehicle 118 can operate on any of a number of wireless networks and in any territory in the world connected to one of the wireless networks. The central service back end 114 can be one or more physical and/or virtual servers. The vehicle 118 is capable of operating in any of a number of wireless networks and provides a single communication path from the vehicle 118 to the central service back end 114. The international connected vehicle platform 100 also includes the central call center 112 that supports voice calls. At the central call center 112, a live, highly skilled, task-trained agent supports the voice call but language-specialized translators can be conferenced in to support the customer in their language of choice as needed. In one exemplary embodiment, the most widely spoken languages can be supported by native speakers in the central call center 112, while other, less prevalent languages and/or dialects are supported as needed through the third-party translation services or by other individuals who may not be co-located with the call center 112 but are available to the call center agents 24 hours a day, 7 days a week.

In one exemplary embodiment, the central service back end 114 and the central call center 112 are co-located. In another exemplary embodiment, the central service back end 114 is separate from one or more call centers 112. In an exemplary embodiment where the call centers 112 are separate from the central service back end 114, one of the central call centers 112 can be selected based on certain criteria, e.g., the number of languages supported by that particular central call center 112. The central service back end 114 can be a single server and/or a geographically diverse redundant set of computers.

In an exemplary embodiment, customer data required to support the connected vehicle services is hosted on cloud-based servers in locations as required by local legislation. Where required by privacy regulations, a secure cloud database (and/or cloud server) 115 is utilized.

In an exemplary embodiment, a customer can access a web portal and application for enrollment and remote services using a device 124. Device 124 can be any device, e.g., a wired or wireless computing device, capable of accessing a web portal and an application. The device 124 can be any wireless communications device such as smartphones and tablets.

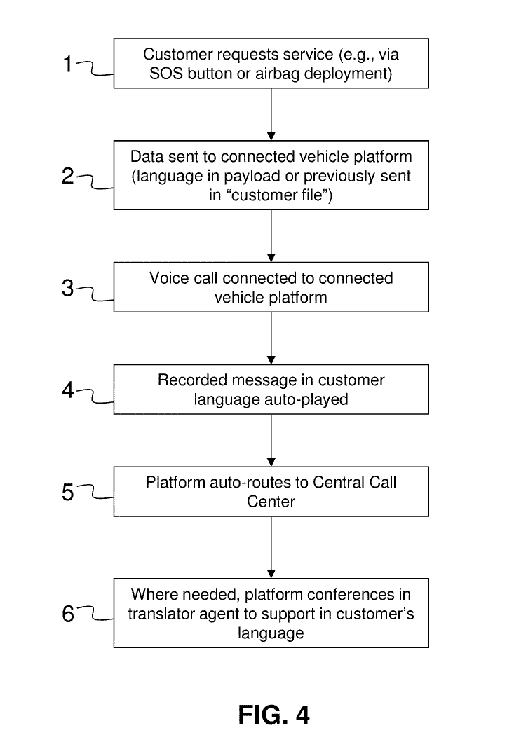

Now will be described an exemplary embodiment of a process for implementing or utilizing international connected vehicle platform 100 with reference to FIG. 4. In Step 1, a customer requests service, for example, through an SOS indicator within the vehicle 118. The SOS indicator can be a button that is actually pressed, for example, by a physical button or an area provided on a touchscreen. The SOS indicator can also be activated using an interactive voice response system. The customer can also request service automatically, for example, after an airbag has been deployed.

In Step 2, data is sent to the international connected vehicle platform 100. The language indicator can be sent within the data payload of the customer request or it can be previously sent to the connected vehicle platform in a “customer file.”

In Step 3, a voice call connects the vehicle 118 to the international connected vehicle platform 100.

In Step 4, a recorded message in the language of the customer is automatically played to the customer.

In Step 5, the international connected vehicle platform 100 automatically routes the customer's call to the central call center 112.

In Step 6, where needed, the central service back end 114 at the central platform 100 conferences in a specialized translator agent to support the customer in the customer's desired language. It is noted that either a live agent or the platform can perform the conference. If the needed language is known in the database of the platform 100 or if the vehicle data contains an identifier for the needed language, then there is no need for live staff participation and the central call center and/or the platform can perform an auto-conference with the appropriate language. Here, the live agent would perform the conference when the language need is identified after the start of the call but not in data.

In another exemplary embodiment, an agent at the central call center 112 conferences in a specialized translator agent to support the customer in the customer's desired language only after identifying through a vocal exchange with the occupant the language needed because the vehicle data or the customer file did not identify that language.

The systems and methods herein are understood to support secure communication throughout the international connected vehicle platform 100, e.g., e.g., between the vehicle 118, the central call center 112, and the device(s) 124.

It is noted that various individual features of the inventive processes and systems may be described only in one exemplary embodiment herein. The particular choice for description herein with regard to a single exemplary embodiment is not to be taken as a limitation that the particular feature is only applicable to the embodiment in which it is described. All features described herein are equally applicable to, additive, or interchangeable with any or all of the other exemplary embodiments described herein and in any combination or grouping or arrangement. In particular, use of a single reference numeral herein to illustrate, define, or describe a particular feature does not mean that the feature cannot be associated or equated to another feature in another drawing figure or description. Further, where two or more reference numerals are used in the figures or in the drawings, this should not be construed as being limited to only those embodiments or features, they are equally applicable to similar features or not a reference numeral is used or another reference numeral is omitted.

The phrase “at least one of A and B” is used herein and/or in the following claims, where A and B are variables indicating a particular object or attribute. When used, this phrase is intended to and is hereby defined as a choice of A or B or both A and B, which is similar to the phrase “and/or”. Where more than two variables are present in such a phrase, this phrase is hereby defined as including only one of the variables, any one of the variables, any combination of any of the variables, and all of the variables.

The foregoing description and accompanying drawings illustrate the principles, exemplary embodiments, and modes of operation of the invention. However, the invention should not be construed as being limited to the particular embodiments discussed above. Additional variations of the embodiments discussed above will be appreciated by those skilled in the art and the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A system for providing centralized connected vehicle services, comprising:
a vehicle communicating through a communications device at least one of:
being a wireless access device embedded within the vehicle; and
being a mobile wireless access device;
the communications device transmitting at least one of:
language data from the vehicle indicating a language spoken by a customer within the vehicle; and
a voice call from the wireless access device;
a central call center communicatively connected to at least one of the vehicle and the wireless access device; and
a central computer server:
co-located with the central call center;
communicatively connected to the central call center;
facilitating the voice call with the wireless access device; and
automatically routing the voice call to the central call center;
the central call center automatically playing a recorded message through the central computer server to the wireless access device in the language of the customer.
